(19) United States
(12) Patent Application Publication
(10) Pub. No.: US 2014/0042078 A1
(43) Pub. Date: Feb. 13, 2014

(54) INCLINED MESH PANEL TYPE FILTERING APPARATUS

(71) Applicant: Blue Whale Screen Co., Ltd., Gyeonggi-do (KR)

(72) Inventor: Doo Yun HWANG, Seoul (KR)

(21) Appl. No.: 13/958,804

(22) Filed: Aug. 5, 2013

(30) Foreign Application Priority Data
Aug. 9, 2012 (KR) 10-2012-0087198

(51) Int. Cl. B01D 29/00

(52) U.S. Cl. CPC B01D 29/0077
USPC 210/413

(57) ABSTRACT

An inclined mesh panel type filtering apparatus capable of easily removing suspended solids from water. In a conventional apparatus, a filtration fabric is contaminated from use even when it is cleaned by a brush unit or a cleaning unit, and is almost clogged, in the course of one to two years after being put into operation, to such an extent that scale is not even removed even by additional manual cleaning. Thus, the entire apparatus should be disassembled to replace the filtration fabric with a new one or exchange an entire filter drum. This problem is resolved by the inclined mesh panel type filtering apparatus that can be continuously operated for a long time in which a filtration panel formed with fine openings having a typical size of 0.2 to 1.2 mm is not clogged and does not require high-pressure cleaning-water or air showers that consume high energy.

CROSS REFERENCE TO RELATED ED APPLICATION(S)

This application claims the benefit of Korean Patent Application No. 10-2012-0087198, filed on Aug. 9, 2012, entitled INCLINED MESH PANEL TYPE FILTERING APPARATUS, which is hereby incorporated by reference in its entirety into this application.

### BACKGROUND OF THE INVENTION

1. Technical Field

The present invention relates generally to a filtering apparatus for water treatment and, more particularly, to an inclined mesh panel type filtering apparatus that removes suspended solids contained in water in a sewage/wastewater or water treatment process in advance of a main treatment process to enhance efficiency.

2. Description of the Related Art

In general, to prevent the machinery of a main treatment process from being damaged due to inflow of coarse debris at the sewage treatment plants, coarse screens having an interval of 50 to 100 mm or fine screens having an interval of 20 to 40 mm are installed in the inflow waterway.

Further, to prevent a problem that fine debris, which are not captured by the coarse or fine screens are introduced in suspended state and adhere to each part of water tanks of the disposal plant or conglomerate late so that pumps or valves become clogged, superfine screens having a slot of 2 to 10 mm are installed.

However, as advanced sewage/wastewater treatment is gradually demanded all over the world, the main treatment process is changed from a simple activated sludge treatment process into a membrane bioreactor (MBR) membrane separation process. The membrane separation process has a problem in that a membrane should be frequently replaced as easily contaminated and clogged by fine debris such as hair passing through even a fine slot having a width of 2 to 3 mm.

Particularly, when a slot-shaped screen is used, hair in sewage very easily passes through even a narrow long slot of 1 mm. The advanced treatment process cannot be operated as long as a large quantity of hair is not removed. In this situation, a screen or a filtering apparatus that has openings in a circular or square shape rather than in a slot shape are required.

Therefore, filters in which a perforated plate manufactured by punching openings on a steel plate in a circular shape and a woven fabric mesh mainly woven with the stainless steel wire are adopted are beginning to be used. In the case of the perforated plate, its manufacturing cost is very expensive, even in the case of a diameter of 0.8 to 1.2 mm. Especially, when the diameter of the perforated plate reaches a range of 0.2 to 0.7 mm, it is difficult to manufacture the perforated plate except by special machining such as electrospark machining, and thus it becomes economically inefficient. Hence, the woven fabric mesh filters are mostly used at present.

In this relation, a system in which a bar type brush scrapes and discharges debris captured on an inclined perforated plate is already disclosed in Patent Document 1. A system for separating debris attached to an endless belt type woven filtration fabric traveling gradually using a high-pressure cleaning shower, and simultaneously cleaning the woven filtration fabric is disclosed in Patent Document 2. In Patent Document 3, it can also be found that debris attached to an endless belt type woven filtration fabric are separated and cleaned by a high-pressure air shower and a high-temperature cleaning water shower operated intermittently.

Meanwhile, in case of the Patent Document 4, Patent Documents 5 and 6 filed in the name of the applicant of this application are cited. Three screens of these documents are all manufactured in such a manner that a rotating screen drum is installed in an inclined fashion in a waterway, that wastewater flows into the end opening below the screen drum and the flows past the slot inside the screen drum, and the debris captured inside the screen drum because they are larger than the slot are rotated and raised, and are dropped to a hopper near a central shaft of the screen drum by a high-pressure cleaning shower water jet toward the center of the screen drum at the outer upper portion of the screen drum, and are discharged upward by a rotating screw mounted in the hopper.

Among them, the screen according to Patent Document 5, cannot capture fine debris having a particle size of 0.2 to 1.2 mm because the screen drum is made of a circular or slit-shaped perforated plate having a diameter of 2 to 10 mm, and the screen according to Patent Document 6 also cannot capture fine debris having a particle size of 0.2 to 1.2 mm because a plurality of annular disks are arranged and assembled with regular slots of about 5 to 10 mm to form and a screen drum and annular slots of the screen drum are scrapped and cleaned by a comb-shaped rake. In the case of Patent Document 4, a drum filter having a particle size of 0.2 to 1.2 mm has been put to practical use by making a filtration drum by attaching the 0.2 to 1.2 mm opening woven mesh filtration fabric to the inner side of a drum manufactured with a high-strength thick grating, which is defined as a shaping carrier element in the specification, so that a woven mesh having a square opening of 0.2×0.2 mm² to 1.2×1.2 mm² can maintain a drum shape and perform a function of a filtration mesh.

### DOCUMENTS OF RELATED ART

(Patent Document 1) Korean Patent No. 10-0044516

(Patent Document 2) Korean Patent No. 10-0905003

(Patent Document 3) U.S. Pat. No. 6,942,786

(Patent Document 4) U.S. Pat. No. 7,160,443

(Patent Document 5) U.S. Pat. No. 4,634,524

(Patent Document 6) U.S. Pat. No. 4,836,919

(Patent Document 7) Korean Patent No. 20-0446633

### SUMMARY OF THE INVENTION

However, in these conventional filtering apparatuses, contrary to the expectation, the openings are gradually clogged over time, and mostly the openings are maintained only when the workers often manually clean the openings using a high-pressure cleaner of 100 bar or more, or by using a chemical cleaning agent. And if once the cleaning is neglected, events that the apparatus should be disassembled to replace the filtration fabric, or should replace the whole filter drum are happening as the cleaning is no longer possible using the high-pressure cleaner, and the filtration fabric is rather damaged. To be more specific, in case of the filter according to Patent Document 1, the filter perished away due to the problem that the bar type brush sweeping the perforated filtration plate for the cleaning never scrapes the interior of the perforations due to the depth while sweeping the upper surface of the filtration plate, and thus the openings are abruptly clogged. Even in case of the endless belt type filter according to the Patent Document 2, its adoption is not expanded at all as the sufficient cleaning of the filter is not achieved as the actual impact power hitting the filter fabric is reduced by several tenths due to the fan type spreading shower even the high-pressure cleaning shower of 3 to 8 bar is continuously sprayed, and as they cannot increase the cleaning water limitlessly due to the huge loss of water and the pumping power cost. This situation is not quitely different in case of the inclined drum type woven mesh filter (Patent Document 4) made by Hans Huber AG (German), who is the worldwide biggest manufacturer of the screen apparatus for wastewater treatment.

In case of the Republic of Korea, 4 sets of inclined drum type woven mesh filters, each of them uses a woven mesh formed of stainless steel having 0.75×0.75 mm² opening, were manufactured by Hans Huber AG and were installed and operated at the Cheonan sewage treatment plant situated at Cheonan City, Chungcheongnam-Province, Korea since 2009. However, the event that all the 4 sets of the machine was lifted up to replace whole filter drums due to the problem that openings of the filtration fabric are gradually clogged frequently even a super high pressure cleaning shower of 120 bar was intermittently operated additionally as the full time operating high pressure shower of 8 bar only seemed insufficient. And even after the whole filter drums are replaced, the workers and operation team is strained always yet. The alternatives of the drum filter cleaner includes the inclined drum type screen apparatus according to Patent Document 5, or the roller brush that is rotated in contact with outside of the filter drum in Patent Document 7. However, the alternatives can be applied only to the case in which, as set forth in these specifications, a filter face that independently maintains a drum shape without the help of any reinforced grating, and a drum made with a perforated plate that has a thickness of 2 to 5 mm and has sufficient strength to overcome the rotational force of the drum or a pressure of treatment or cleaning water. So a filter drum having fine openings of 0.2 to 1.2 mm cannot be put to practical use by the perforated plate having this thickness.

Thus, to make a filter drum having fine openings of 0.2 to 1.2 mm, as in the case of the inclined drum type woven mesh filter according to Patent Documents 4, a very thin woven mesh or a perforated plate having fine openings of 0.2 to 1.2 mm should be reinforced by a separate thick grating of high strength. Here, when the reinforced grating mesh is located on the inner side of the drum where there is an inflow of sewage and wastewater, corners of the filtration mesh that are in contact with the reinforced grating are abruptly covered with scale by flow resistance around the reinforced grating, and as the scale grows, eventually the entire filtration mesh is almost clogged.

This is the reason why the inclined drum type woven mesh filters according to Patent Document 4, locate the mesh fabric at the inside of the drum, accepting the difficulty that attaching the mesh to the outer drum grating so as to make the mesh does not sagged inside of the drum. However, in the case that the filter drum is made in this way, the reinforced grating is located at the side of the outer surface of the drum, and any additional reinforced beams are required to withstand the rotating torsion force. Therefore we meet the problem that the roller brush type cleaner cannot be used for cleaning the filter drum for the fine opening of 0.2 to 1.2 mm as the contact of the roller brush hair with the filter mesh of the drum inner face is absolutely difficult due to the interruption of the grating and the reinforcing beams.

Accordingly, the object of the present invention is to easily solve the problem that the filtration fabric of the filter having fine openings of a typical size of 0.2 to 1.2 mm becomes clogged over time.

Another object of the present invention is to provide a panel type filtering apparatus in which, even in the case of the filter having the fine openings of a typical size of 0.2 to 1.2 mm, a filtration fabric can be continuously operated without becoming clogged, without the loss of cleaning water or the loss of power for the cleaning shower pump.

In order to accomplish the above object, the present invention provides an inclined mesh panel type filtering apparatus, which includes: a filtration panel that is installed in an inclined fashion on a waterway so as to remove suspended solids included in water in a sewage/wastewater or water treatment process and has fine openings; a pair of side frames that are installed at both sides of the filtration plate; bar type brushes whose both ends are connected to left and right side chains installed inside of the frames, and which scrape and discharge the suspended solids captured on the filtration panel while traveling; and a roller brush whose both ends are connected to left and right chains installed inside of the side frames, and whose brush hairs thrust into clogged openings while being rotated to travel by the contact with filtration panel.

Here, the filtration panel may be a woven mesh fabric that is plain-woven with stainless steel wire or with polyester mono filament.

Further, the roller brush may have a cylindrical brush cover installed therearound.

In addition, the filtration panel may be formed in one piece or in several pieces, and the side frames may include stoppers so as to mount or demount the filtration panel.

According to the present invention, the bar type brushes sweep and discharge debris attached to the upper face of the filtration panel, and just after the brushes are exposed, the roller bush is rotated by the contact of brush hairs with the filtration panel, and ends of the brush hairs thrust and open the fine openings of the filtratin panel while the roller brush is traveling. Thereby, the filtration panel can be cleanly maintained without becoming clogged even after long-term operation.

Therefore the loss of considerable quantity of cleaning water and the big loss of power for high pressure air compressor can be prevented as the fine openings can be maintained without becoming clogged even without the cleaning shower equipment or the air shower equipment. And the problem that high-pressure cleaning water vapor is scattered to make the entire treatment plant humid can also be solved, and the structural problem of the endless belt type filters, which is the carry-over problem that some debris which were not removed by the take off shower completely are attached at the filtration fabric, and are turned toward the rear of the machine and discharged to the filtered effluent, can be substantially prevented with the effect that the pleasant noise-free working environment can be maintained as the high-pressure air shower cleaning is not necessary.

Furthermore, if compared to the inclined drum type woven mesh filter that has recently been adopted mostly and is disclosed in Patent Documents 4, present invention has the advantage that the initial installation cost can be less than half of the drum type filter which has very heavy filter drum and the supporting structures for rotating the drum with the big driving motor, and has the high pressure cleaning showers and pumps, when we consider the substantial problem thatonly about 25% of the entire drum is immersed in the water when filtration is performed, and the entire filter drum that is very bulky and heavy is rotated at all times, and the high-pressure cleaning shower should also be operated at all times.

Moreover, only the traveling loads of the bar type brushes traveling by the chains and the sprockets installed on both side frames, and the traveling load of the roller brush corresponds to overall machine driving loads. So, the overall drive power cost is within 20% of that for rotating the drum of the inclined drum type, and is within 10% when considering even the power cost of the high-pressure pump. As the result, the power cost is reduced by 90%, and thus tremendous maintenance expenses are reduced.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a side cross-sectional view showing a filtering apparatus according to an embodiment of the present invention;

FIG. 2 is a front view showing the filtering apparatus according to the embodiment of the present invention;

FIG. 3 is a perspective view showing a filtration panel according to the embodiment of the present invention; and

FIG. 4 is a cross-sectional view showing a lower portion of the filtering apparatus according to the embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the terms to describe most appropriately the best method he or she knows for carrying out the invention.

The above and other objects, features and advantages of the present invention will be more clearly understood from the following detailed description taken in conjunction with the accompanying drawings. Herein, the same reference numerals are used throughout the different drawings to designate the same components. While such terms as “first,” “second,” “one face,” “the other face,” etc., may be used to describe various components, such components must not be limited to the above terms. Further, when it is determined that the detailed description of the known art related to the present invention might obscure the gist of the present invention, the detailed description thereof will be omitted.

Reference now should be made to the drawings, in which the same reference numerals are used throughout the different drawings to designate the same or similar components.

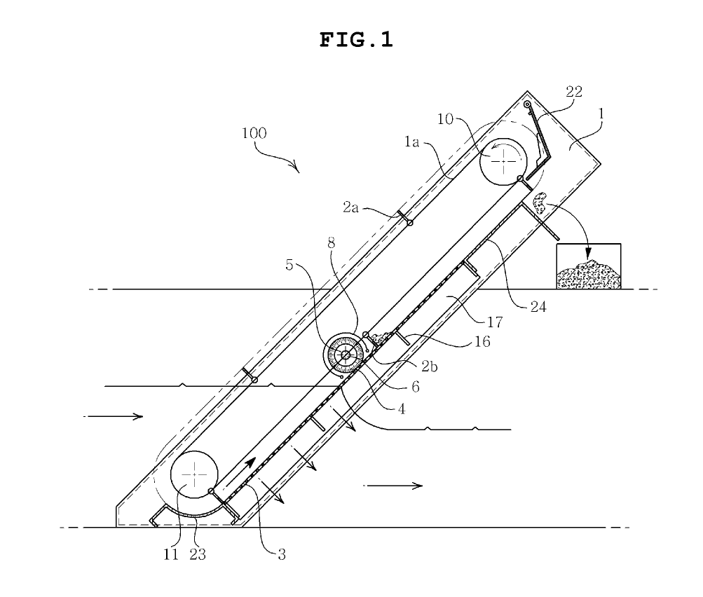

As shown in FIG. 1, an inclined mesh panel type filtering apparatus 100 according to the present invention is designed to remove suspended solids included in water in a sewage/wastewater or water treatment process, particularly in a pre-treatment process. As one example, when viewed in reference to FIG. 1, the suspended solids are removed by water flowing from the left to the right

That is, the inclined mesh panel type filtering apparatus 100 according to the present invention is designed so that bar type brushes 2a and 2b, which travel with both ends thereof connected to left and right chains 1a installed inside of the side frames 1, sweep upward the upper face of the filtration panel 3 inclinedly installed on a waterway of the pre-treatment process and discharge the suspended solids captured on the upper face of the filtration panel 3.

Here, the discharge of the suspended solids is adapted to use a method in which the suspended solids swept upward by the bar type brushes 2a and 2b go up across an extension plate 24, which is installed at the upper end of the filtration panel 3 so as to support the suspended solids, and then are scraped downward by a scraper 22 installed at upper portions of the side frames 1.

A roller brush 5, which is rotated to travel by contact of brush hairs 4 with the filtration panel 3, is disposed directly behind the bar type brush 2a or 2b. The ends of the brush hairs 4 thrust into clogged fine openings of the filtration panel 3 to open the clogged fine openings.

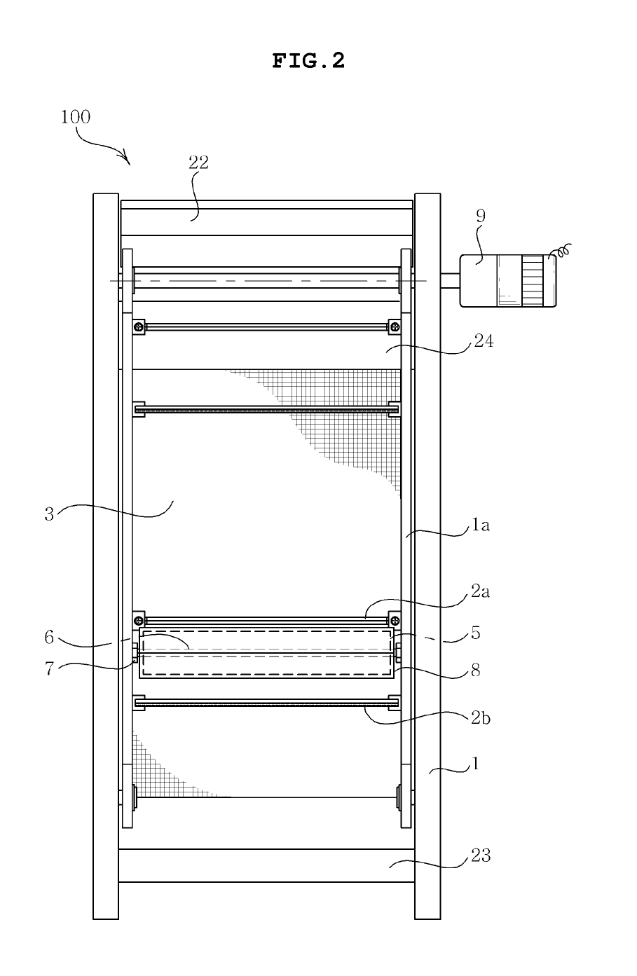

As shown in FIG. 2, the roller brush 5 is rotatably installed between the pair of side frames 1 and travels with a central shaft 6 thereof fitted into oil-less bearings 7 attached to the left and right chains 1a. Here, in a state in which the central shaft 6 of the roller brush 5 is fastened to chain attaches by bolts, only a cylinder which is made of synthetic resin and into which the brush hairs 4 are implanted may be rotated outside the central shaft 6, or both of the central shaft 6 and the cylinder may be rotated together.

The brush hairs 4 are formed of a nylon material having high elasticity and have a diameter of less than half of the fine opening formed in the filtration panel 3 so that two of the brush hairs 4 can simultaneously thrust into one fine opening. Pig bristles or horsehair may be used as the brush hairs 4 depending on a size of the fine opening and a type or temperature of sewage/wastewater.

Here, in case of the sewage/wastewater, many long debris such as hairs are included in the sewage/wastewater, and get twisted around the brush hairs 4 of the roller brush 5. Hence, the roller brush 5 is preferably surrounded with a cylindrical brush cover 8. However, since the filtration panel 3 and the brush hairs 4 should be in contact with each other, the brush cover 8 surrounds a circumference of about 270° except the contact portion. Further, the brush cover 8 may cover an upper end of the bar type brush 2a, which is located just before the brush cover 8, and be partly supported on and fixed to the upper end of the bar type brush 2a.

The chains 1a traveling the bar type brushes 2a and 2b and the roller brush 5 are rotated by connection to driving sprockets 10 driven by a driving motor 9 located at the upper ends of the side frames 1 and driven sprockets 11. The chains 1a may be guided and travel in a straight traveling direction by guide rails 1b attached inside the side frames 1.

That is, the bar type brushes 2a and 2b and the roller brush 5 continuously travel between a scraper 22 and a lower frame 23 along the chains 1a connected to the driving sprockets 10 connected to the driving motor 9 and the driven sprockets 11.

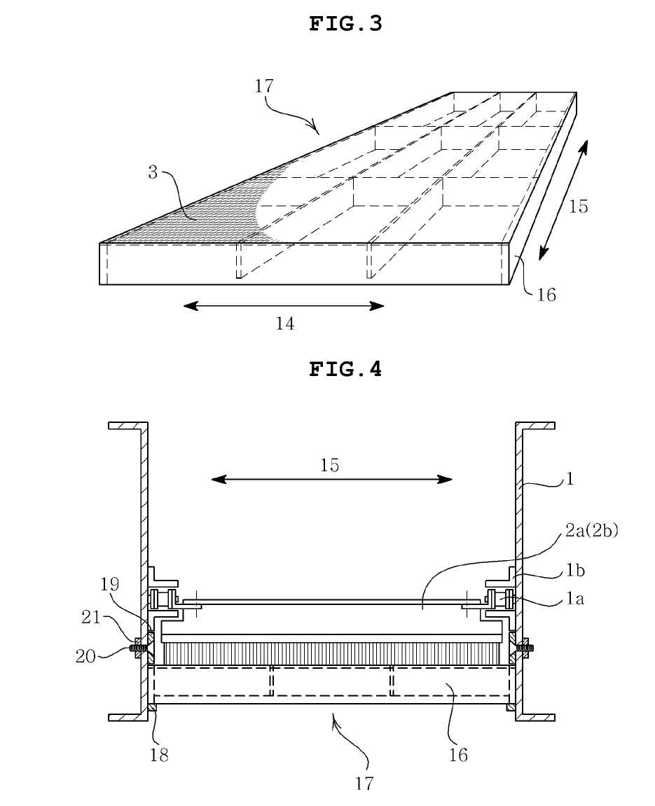

Meanwhile, the filtration panel 3 is typically formed with the fine openings having a size of 0.2 to 1.2 mm To easily realize the fine openings, a woven mesh fabric that is plain woven with a stainless steel wire or a polyester mono filament is used. This is economical compared to a perforated plate punching the fine openings and is advantageous from the viewpoint of an opening ratio. And the woven mesh fabric has the advantage of prolonging lifetime of the brush hairs 4 several times as the repulsive resistance which the brush hairs 4 meet when thrusting the closed part of the filtration panel 3 while the brush 5 thrusts the filtration panel 3 to the predetermined depth is far low. As shown in FIG. 3, to maintain the flatness, the woven mesh fabric for the filtration panel 3 is pulled and stretched with proper tension on a filtration panel frame 16 made so as to support the rear face of the mesh fabric at proper intervals in the longitudinal direction 14 and the cross direction 15 using flat straps of stainless steel. In this state, contact faces of the filtration panel frame 16 and the mesh fabric are adhered with a synthetic resin adhesive such as an epoxy adhesive or are welded using a low-current argon welding machine Thereby a filtration panel assembly 17 is formed.

The filtration panel assembly 17 may be made up of one filtration panel 3 made in one piece or several filtration panels 3 made so as to be divided into several pieces in the longitudinal direction 14, and the filtration panel assembly 17 may be fastened at the bottom between the side frames 1 by bolts.

As shown in FIG. 4, the filtration panel assembly 17 may be replaced and installed on the stoppers 18 which are previously welded on the inside of the side frames 1 after removing the old panel toward the front in the state that the filtering apparatus is installed in the waterway when the filtration panel 3 is damaged. In this case, the filtration panel assembly 17 is pressed and fastened using the flathead bolts 20 and fixing nuts 21 which is TAG-welded at the outside of the side frames 1, with the fixing pieces 19 of the front side.

Here, to prepare for the case in which the filtration panel 3 is damaged after long operation, immediate measure can be secured if precise level sensors such as ultrasonic level sensors can be installed at the upstream and downstream of the filtering equipment, and made to initiate an alarm when the water level difference gets down to below the designated level. Thus, the inclined mesh panel type filtering apparatus 100 according to the embodiment of the present invention is maintained without the clogging of the filtration panel 3 after the long-term operation unlike the existing woven mesh fabric type filters which the fiter fabrics are clogged and should be replaced even the additional manual cleaning is typically performed in every 3-4 months. Therefore, the filter in which fine openings having a size of 0.2 to 1.2 mm, can be easily realized.

Although the embodiments of the present invention have been described for illustrative purposes, the inclined mesh panel type filtering apparatus of the present invention is not limited to the embodiments. Those skilled in the art will appreciate that various modifications, additions and substitutions are possible, without departing from the scope and spirit of the invention as disclosed in the accompanying claims.

Accordingly, simple modifications or variations belonging to the scope of the present invention, and the specific protection scope of the present invention will be definitely defined by the appended claims.

What is claimed is:

1. An inclined mesh panel type filtering apparatus comprising:
a filtration panel that is installed in an inclined fashion on a waterway so as to remove suspended solids included in water in a sewage/wastewater or water treatment process and has fine openings;
a pair of side frames that are installed at both sides of the filtration panel;
bar type brushes whose opposite ends are connected to left and right chains installed inside of the side frames, and which scrape and discharge the suspended solids captured on the filtration panel while traveling; and
a roller brush both ends are connected to left and right chains installed inside of the side frames, and whose brush hairs thrust into clogged openings while being rotated to travel by the contact with filtration panel.

2. The inclined mesh panel type filtering apparatus as set forth in claim 1, wherein the filtration panel is a woven mesh fabric that is plain woven with a stainless steel wire or a polyester mono filament.

3. The inclined mesh panel type filtering apparatus as set forth in claim 1, wherein the roller brush has a cylindrical brush cover installed therearound.

4. The inclined mesh panel type filtering apparatus as set forth in claim 1, wherein the filtration panel is formed in one piece or in several pieces, and the side frames include stoppers so as to mount or demount the filtration panel.

5. The inclined mesh panel type filtering apparatus as set forth in claim 2, wherein the filtration plate is formed in one piece or in several pieces, and the side frames include stoppers so as to mount or demount the filtration plate.

6. The inclined mesh panel type filtering apparatus as set forth in claim 3, wherein the filtration plate is formed in one piece or in several pieces, and the side frames include stoppers so as to mount or demount the filtration plate.
